(19) United States
(12) Patent Application Publication
(10) Pub. No.: US 2006/0015368 A1
(43) Pub. Date: Jan. 19, 2006

(54) Portable method and device for personal medical record compilation and retrieval

(76) Inventor: Sanford Hockey, Cleveland Heights, OH (US)

Correspondence Address: Richard M. Klein, Esq.;Fay, Sharpe, Fagan, Minnich & McKee, LLP, Seventh Floor, 1100 Superior Avenue, Cleveland, OH, 44114-2579, US

(21) Appl. No.: 11/179,845

(22) Filed: Jul. 12, 2005

Related U.S. Application Data
(60) Provisional application No. 60/587,566, filed on Jul. 13, 2004.

(51) Int. Cl. G06Q 10/00

(52) U.S. Cl. 705/2

(57) ABSTRACT

A medical information device includes a portable USB memory drive adapted for detachable connection with a USB port of a computer. A current medical profile Portable Document Format (PDF) file is stored on the portable USB memory drive unencrypted and without password protection. The current medical profile PDF file contains information relevant to delivering emergency aid to an associated person in the event of a medical emergency. Visual indicia are coupled with the portable USB memory drive to alert emergency personnel that the portable USB removable memory drive contains information relevant to delivering emergency aid to the associated person.

### BACKGROUND

This application claims the benefit of U.S. Provisional Application No. 60/587,566, filed Jul. 13, 2004. U.S. Provisional Application No. 60/587,566 is incorporated herein by reference in its entirety.

The following relates to the medical information and data arts. It especially relates to apparatuses for medical record compilation, storage, and retrieval in the for rapid retrieval during emergency medical situations, and will be described with particular reference thereto. However, the following will also find application in conjunction with other like applications.

Emergency medical personnel refer to the first hour after a heart attack, stroke, automobile accident, or other catastrophic medical trauma as the “golden hour” during which the rapidity and quality of medical care often determines the outcome. Children with special medical needs, elderly with chronic medical illnesses, and other persons with special medical conditions or needs are at enhanced risk in the initial hour or hours after a traumatic medical event, because emergency medical personnel may be treating the injured person without knowledge of those special medical conditions or needs. For example, a hemophiliac injured in an automobile accident can expire due to internal bleeding unless appropriate preventative measures are immediately taken. Such concerns are enhanced when the injured person is traveling, when the injury occurs at night, or at other times or places in which access to the person's medical records is likely to be delayed or prevented.

Even if the injury occurs close to home, rapid access to key medical records may be hindered. Under federal mandates established by the Health Insurance Portability and Accountability Act (HIPAA), access to a critically injured person's medical records by a remote care facility may be denied or substantially delayed. HIPAA also encourages health care providers (such as hospitals, home health care providers, pharmacies, clinics, physician's offices, and so forth) to encrypt medical records identifiable with an individual when they are transmitted or communicated. Thus, even if medical records are physically available to emergency medical personnel, privacy-related encryption or other electronic security measures may delay or bar access to the information contained in those records.

Lack of ready access to medically-related legal documents, such as treatment consent authorization, power of attorney, and living will documents, may cause emergency medical personnel to hesitate to apply appropriate interventional procedures or may lead emergency medical personnel to perform unwanted extraordinary life-saving interventions.

Approaches for conveying medically related information rapidly and reliably to emergency medical personnel have heretofore been less than fully satisfactory. Medical alert bracelets and similar items are worn by persons with special medical conditions to alert emergency medical personnel to those special medical conditions in the event of a medical emergency. However, the amount of information that can be conveyed by such items is limited. Another approach is for the person with special medical needs to carry paper copies of key medical records. While this enables more information to be carried, it is inconvenient for the person. Additionally, paper copies are prone to damage or destruction.

### BRIEF SUMMARY

According to one aspect, a medical information device is disclosed. A portable non-volatile digital memory device is adapted for detachable connection with a computer. At least one current medical profile data file is stored unencrypted and without password protection on the portable non-volatile digital memory device. The at least one current medical profile data file contains information relevant to delivering emergency aid to an associated person in the event of a medical emergency.

According to another aspect, a medical information device is disclosed. A portable USB memory drive is adapted for detachable connection with a USB port of a computer. A current medical profile Portable Document Format (PDF) file is stored on the portable USB memory drive and contains information relevant to delivering emergency aid to an associated person in the event of a medical emergency. Visual indicia are coupled with the portable USB memory drive to alert emergency personnel that the portable USB memory drive contains information relevant to delivering emergency aid to the associated person

According to another aspect; a medical information retrieval method is disclosed. A portable non-volatile digital memory device adapted for detachable connection with a computer is carried. The portable non-volatile digital memory device stores a current medical profile data file unencrypted and without password protection. The current medical profile data file contains information relevant to delivering emergency aid to an associated person carrying the portable non-volatile digital memory device in the event of a medical emergency. Responsive to a medical emergency, the portable non-volatile digital memory device is connected with a computer. After the connecting, the stored current medical profile data file is opened using a general-application software program not residing on the portable non-volatile digital memory device.

### BRIEF DESCRIPTION OF THE DRAWINGS

FIG. 1 shows a medical information device including a non-volatile digital memory device storing a current medical profile data file and having coupled visual indicia alerting emergency personnel that the portable non-volatile digital memory device stores information relevant to delivering emergency aid to the associated person.

FIG. 2A shows a computer including a USB port before connecting the medical information device of FIG. 1.

FIG. 2B shows the computer of FIG. 2A after connecting the medical information device of FIG. 1 and opening the current medical profile data file.

FIG. 3 diagrammatically shows the computer and the medical information device including representations of selected software and data file components.

FIG. 4 shows an example front page displayed by the opened current medical profile data file, showing a critical care protocol and medical insurance card.

FIG. 5 shows PDF bookmarks of an example current medical profile data file having a PDF format.

FIG. 6 shows an example list of medications suitably contained in the current medical profile data file.

FIG. 7 shows an example list of allergies suitably contained in the current medical profile data file.

FIG. 8 shows an example radiological image and associated annotations suitably contained in the current medical profile data file.

FIG. 9 shows portions of an example living will suitably contained in the current medical profile data file.

### DETAILED DESCRIPTION OF PREFERRED EMBODIMENTS

With reference to FIG. 1, 2A, 2B, and 3, a medical information device 8 includes a portable non-volatile digital memory device 10 adapted for detachable connection with a computer 12, such as a laptop computer carried by an emergency medical service (EMS) ambulance, a hospital computer, or another computer accessible by emergency medical personnel. The portable non-volatile digital memory device 10 stores at least one current medical profile data file 14 pertaining to an associated person who carries the medical information device 8. The current medical profile data file 14 contains information relevant to delivering emergency aid to the associated person in the event of a medical emergency. Optionally, the portable non-volatile digital memory device 10 stores other files, such as an optional independent educational program (IEP) file 15.

To facilitate emergency medical personnel recognizing the medical information device 8, the medical information device 8 preferably includes visual indicia 18 alerting emergency personnel that the portable non-volatile digital memory device stores information relevant to delivering emergency aid to the associated person. For example, the illustrated visual indicia 18 include textual information 18₁ and a recognized medical symbol 18₂. In some embodiments, the visual indicia may include a trademark or other proprietary symbol having acquired significance that the marked device stores information relevant to delivering emergency aid to the associated person. In the illustrated embodiment, the visual indicia 18 comprise a label, engraving, or other visual indicia directly coupled with the portable non-volatile digital memory device 10. In other embodiments, the visual indicia may be coupled with the non-volatile digital memory device 10 more indirectly. For example, the non-volatile digital memory device 10 may include a key ring hole 20 for securing the non-volatile digital memory device 10 to a lanyard, key ring, or so forth (not shown), and suitable visual indicia may be disposed on or with the lanyard, key ring, or other secured item.

To facilitate ready access by emergency medical personnel to the information contained in the current medical profile data file 14, the current medical profile data file 14 is preferably stored on the portable non-volatile digital memory device 10 unencrypted and without password protection. Further, the portable non-volatile digital memory device 10 preferably employs standard interfacing hardware for connecting with the computer 12. In the illustrated embodiment, the portable non-volatile digital memory device 10 includes a Universal Serial Bus (USB) interface 22 for detachably connecting with a USB port 24 of the computer 12. However, the use of other standard interfacing hardware is also contemplated. The illustrated portable non-volatile digital memory device 10 is a USB FLASH memory drive. In other embodiments, the portable non-volatile digital memory device may be a small portable hard disk drive with detachable USB connector, or so forth.

In operation, the associated person carries the medical information device 8 on his or her person, for example on a lanyard around the associated person's neck, on the associated person's key ring, in a pocket of the associated person, or so forth. In the event of a medical emergency, arriving emergency medical personnel recognize the medical information device 8 based on the visual indicia 18, and insert the USB memory drive 10 into the USB port 24 of the available computer 12. For example, the ambulance or other emergency response vehicle may carry a laptop computer with one or more USB ports, or the emergency room may include a computer with one or more USB ports. The current medical profile data file 14 is preferably stored in a non-proprietary format such as Portable Document Format (PDF), hypertext markup language (HTML), or so forth, and is preferably unencrypted and without password protection. Such non-propnretary unencrypted and non-password protected files are readily accessible by emergency medical personnel using a general-application software program. For example, in the illustrated embodiment the current medical profile data file 14 is an unencrypted PDF file without password protection, and is readily readable by the computer 12 using a copy of Adobe PDF Reader 26 executed by the computer 12. Adobe PDF Reader is a free program available from Adobe Systems Inc. (San Jose, Calif.) that can be downloaded for free via the Internet (see http://www.adobe.com/). Because of the ubiquity of PDF formatted files and the free availability of Adobe PDF Reader, most medical computers include the capability of reading PDF files. Similarly, most medical computers include Internet Explorer (available from Microsoft Corp., Redmond, Wash.), Netscape Navigator (available from Netscape Communications Corp., Mountain View, Calif.), or another web browser capable of reading HTML files. In other embodiments, the current medical profile data file 14 is stored in a proprietary but widely available general-application format such as Microsoft Word (available from Microsoft Corp., Redmond, Wash.), which is a proprietary word processing application program that is installed on many medical computers. Using a proprietary application platform such as Microsoft Word has the disadvantage of limiting accessibility of the current medical profile data file 14 to those emergency medical care providers who have purchased or otherwise obtained the proprietary application software.

In some embodiments, the portable non-volatile digital memory device 10 does not store a copy of the Adobe PDF reader program or other computer executable instructions for accessing the at least one unencrypted medical data file. Rather, the Adobe PDF reader program 26 is stored on a hard disk drive the computer 12, or on a hospital network, or on another non-volatile memory device other than the portable non-volatile memory device 10. In some embodiments, the portable non-volatile digital memory device 10 does not store any files containing computer executable instructions. In this way, the emergency medical personnel are reassured that the portable non-volatile digital memory device 10 does not contain a virus or other malignant executable code that could damage an emergency medical computer with which the portable non-volatile digital memory device 10 is connected. This reassurance further increases the likelihood that emergency medical personnel will open and access the current medical profile data file 14 containing information relevant to delivering emergency aid to the associated person in the event of a medical emergency. Moreover, in some embodiments the portable non-volatile digital memory device 10 does not store any files other than the current medical profile data file 14. By storing only the current medical profile data file 14 on the portable non-volatile digital memory device 10, emergency medical personnel have only one selection option and are assured of selecting the right file to access the medical information. In other embodiments, other data files may be stored, such as the optional independent educational program (IEP) file 15 providing the current independent educational program for the associated person if the associated person is a handicapped child. An individualized IEP is mandated by federal and some state laws for each handicapped child, and typically provides information such as: the child's assessed level of educational performance; educational goals specific to the handicapped child; special educational, service, or aid requirements; and so forth. Because the IEP is mandated to be readily accessible to the child's educators, the IEP 15 is optionally also stored on the portable non-volatile digital memory device 10. If additional files are included on the portable non-volatile digital memory device 10, then the filenames for the current medical profile data file 14 and for the IEP 15 or other additional files should clearly identify the current medical profile data file 14 as containing information relevant to delivering emergency aid to the associated person in the event of a medical emergency, so that emergency medical personnel can readily identify which file contains the relevant information in an emergency situation.

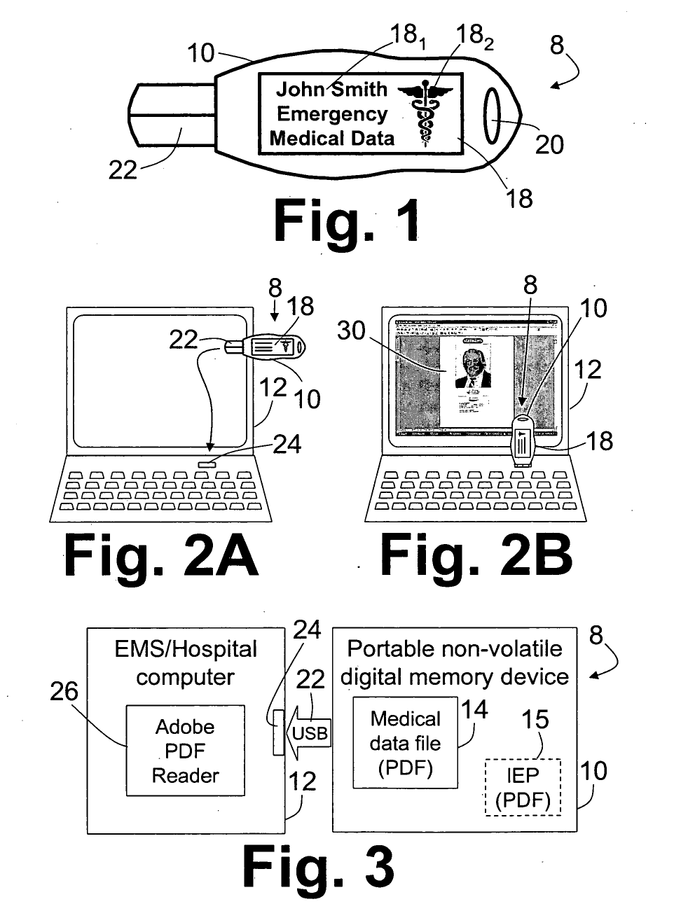

In the illustrated embodiment in which the portable non-volatile digital memory device 10 is a USB FLASH memory drive, or in embodiments in which the portable non-volatile digital memory device 10 is a small portable hard disk drive with detachable USB connector, the USB connector 22 is inserted into the USB port 24 of the computer 12. When inserted, the USB FLASH memory drive or portable hard disk drive appears on the computer 12 as a removable drive containing the unencrypted current medical profile data file 14 without password protection. FIG. 2A shows the computer 12 including the USB port 24; FIG. 2B shows the computer 12 with the portable non-volatile digital memory device 10 connected, after the user has opened the current medical profile data file 14.

Because the current medical profile data file 14 is in a non-proprietary format such as PDF without encryption or password protection, emergency medical personnel can open the current medical profile data file 14 using substantially any suitable file-opening technique. For example, emergency medical personnel can load a copy of Adobe PDF Reader 26 and then use it to open the current medical profile data file 14, or can open Internet Explorer, Netscape Navigator, or another program that accepts Adobe PDF Reader 26 as a “plug-in” software component, and open the current medical profile data file 14 using that program. In another approach, emergency medical personnel can use Windows Explorer or another folders browser to select the current medical profile data file 14, upon which selection the computer 12 automatically recognizes the current medical profile data file 14 as a PDF file and opens the current medical profile data file 14 using Adobe PDF Reader 26. In other example embodiments, the current medical profile data file 14 is an HTML file which is suitably opened by a browser such as Internet Explorer, Netscape Navigator, or so forth. The HTML file can also be opened by selecting it in Windows Explorer or another folders browser, upon which selection the computer automatically recognizes the current medical profile data file as an HTML file and opens it using the computer's default browser.

As shown in FIG. 2B, when the current medical profile data file 14 is opened using Adobe PDF Reader 26 or another PDF reading program, the computer 12 displays a front page 30. In the illustrated embodiment, the front page includes a photograph or other image of the associated person so as to enable emergency medical personnel to verify that the current medical profile data file 14 is for the patient under emergency care, along with text below the picture providing information for immediate consideration by emergency medical personnel.

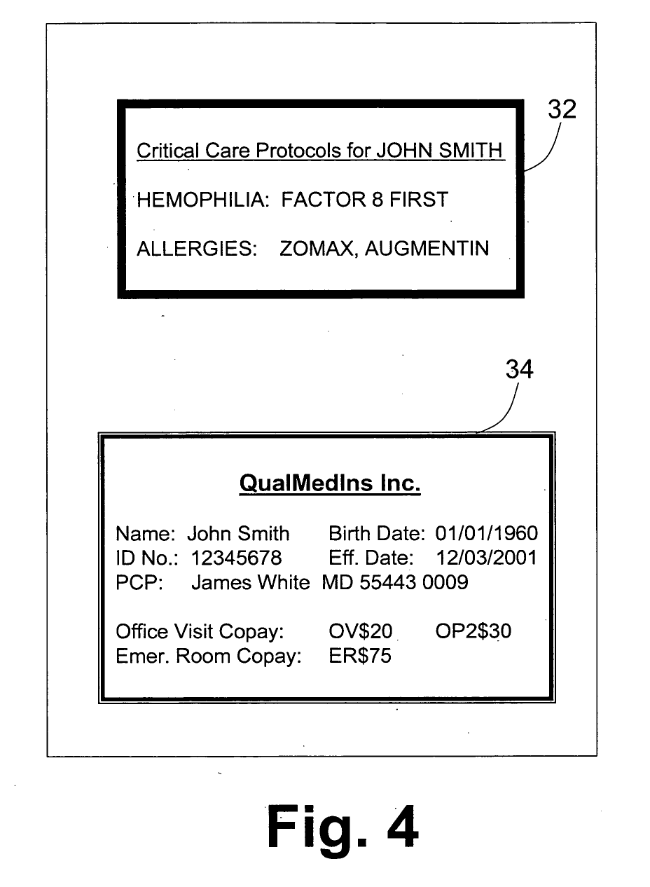

With reference to FIG. 4, other examples of information that is optionally displayed on the front page for immediate consideration by emergency medical personnel may include an emergency aid protocol 32 specifically tailored to the associated person. The example critical care protocols 32 identify the associated person (that is, the person under emergency medical care) as (for example) “JOHN SMITH”, identify in important medical condition (hemophilia, for example) of immediate interest to emergency medical personnel, provide a first aid protocol—“HEMOPHILIA: FACTOR 8 FIRST” which is tailored to the special condition of the associated hemophiliac person, and identify drug allergies—“ALLERGIES: ZOMAX, AUGMENTIN” that should be recognized when giving emergency medical care to the associated person. It is noted that this information is not a complete medical history, which would overwhelm emergency medical personnel with too much information; rather, the emergency aid protocol 32 provides the information of which emergency medical personnel should be immediately aware so as to ensure that they provide care appropriate to the medical conditions, allergies, or other characteristics of the associated person under emergency medical care. With continuing reference to FIG. 4, the front page may display other information that emergency medical personnel may want to immediately access, such as a copy of the associated person's medical insurance card 34.

The front page, such as the examples of FIGS. 2A and 4, provides information, such as patient identification, important medical conditions (such as hemophilia, drug allergies, and so forth), medical insurance information, and so forth, that should be brought to the immediate attention of emergency medical personnel.

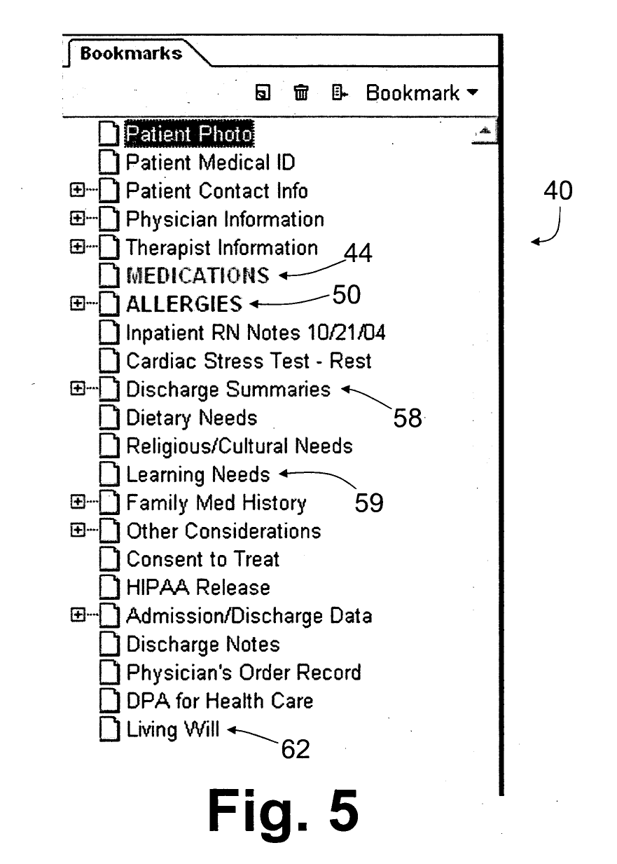

With reference to FIG. 5, the current medical profile data file 14 includes other information which in PDF format embodiments is suitably indexed using PDF bookmarks 40. The current medical profile data file 14 including PDF bookmarks can be readily created using Adobe Acrobat (available from Adobe Systems Inc., San Jose, Calif.) or other commercially available software. Adobe Acrobat includes a plug-in “PDFwriter” printer driver for numerous word processing, presentation, and other application software programs. Using this approach, the current medical profile data file 14 is created in PDF format by scanning, typing, or otherwise generating or capturing electronic medical records or other medical information and “printing” the digitized or captured information to a PDF file using suitable application software and the “PDFwriter” printer driver. Because PDF is an open standard, other programs are commercially available for producing the current medical profile data file 14 in PDF format including the PDF bookmarks 40 from digitized or otherwise electronically captured or generated information about the associated person.

In other example embodiments, the current medical profile data file 14 is in HTML format, and is indexed by a set of hyperlinks defming a menu or the like. Such an indexed current medical profile data file 14 in HTML format can be created, for example, by various application software programs that allow saving in HTML format. Alternatively, an HTML editor can be used to generate the current medical profile data file 14 in HTML format including a menu of hyperlinks. In some contemplated embodiments in which the at least one current medical profile data file 14 is stored as HTML on the USB memory drive 10, the at least one current medical profile data file 14 includes image, text, and/or data files stored in a directory or file folder of the USB memory drive 10, and an HTML file in the root directory of the USB memory drive 10 which contains hyperlinks to the files in the directory or file folder. In this way, emergency medical personnel are likely to select the single HTML file in the root directory, which will then provide rapid indexed access to the image, text, and/or data files stored in a directory or file folder of the USB memory drive 10.

The bookmarked or otherwise indexed information can include, for example: patient photo (such as is shown in FIG. 2B); patient medical ID (such as the medical insurance card 34); patient physician information (optionally including primary physician, specialist physicians, or so forth); therapist information (such as a physical therapist, a dietary therapist, a psychologist, a psychiatrist, or so forth); a list of medications; a list of allergies (optionally including drug allergies, food allergies, or so forth); in-patient nurse notes from recent hospitalizations; recent hospital admission and/or discharge summaries; dietary needs; religious or needs (such as a kosher diet, vegetarian diet, or so forth adhered to by the associated person); learning needs; family medical history; cardiac stress test data; radiological images; other medical test results; and so forth. The content of the current medical profile data file 14 is optionally limited to recent medical history and other information providing a current medical profile of information of greatest relevance to providing emergency medical care. In this way, emergency medical personnel are not overwhelmed by dated or otherwise less relevant information. Additionally, by limiting the information to current material that is relevant to providing emergency medical care for the associated person, potentially embarrassing and irrelevant information contained in the associated person's complete medical history can be omitted from the unencrypted current medical profile data file 14.

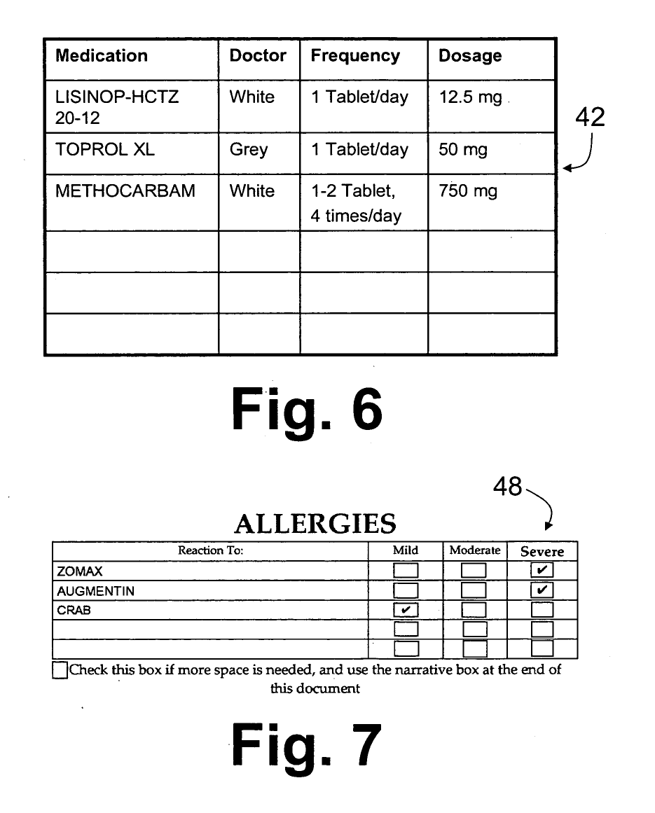

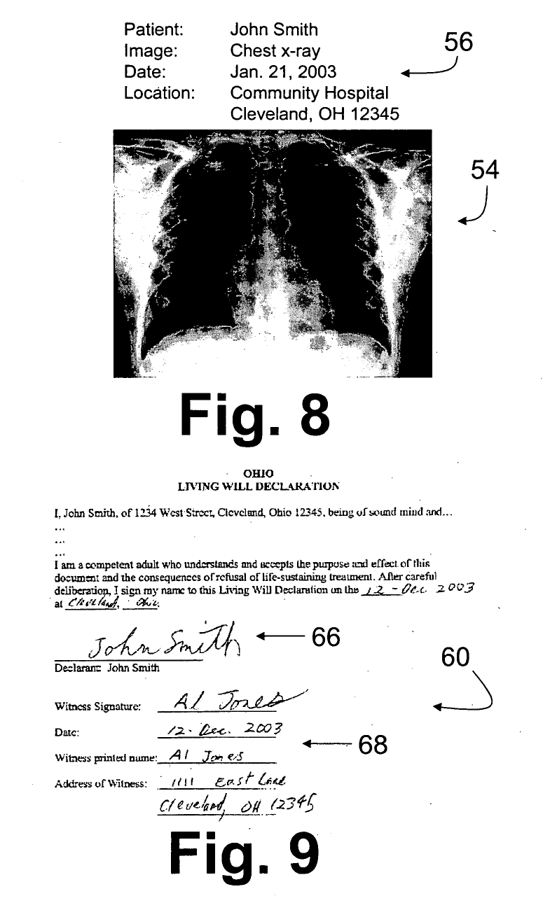

FIGS. 6, 7, and 8 provide some examples of suitable content of the current medical profile data file 14. FIG. 6 shows a table of medications 42 currently being taken by the associated person. With brief reference back to FIG. 5, the medications table 42 is suitably accessed by emergency medical personnel by selecting a “MEDICATIONS” bookmark 44 of the PDF bookmarks 40. Because the table of medications 42 is often of immediate importance to emergency medical personnel, the “MEDICATIONS” bookmark 44 is optionally displayed in red, boldfaced, or otherwise highlighted. Similarly, FIG. 7 shows a list of allergies 48 that is accessed by an “ALLERGIES” bookmark 50 of the PDF bookmarks 40. Again, in view of the potentially immediate importance of allergies to emergency medical personnel, the “ALLERGIES” bookmark 50 of the PDF bookmarks 40 is optionally displayed in red, boldfaced, or otherwise highlighted. FIG. 8 shows a radiological image 54, in the illustrated example a chest x-ray, along with annotations 56 identifying the radiological image 54. Images such as the radiological image 54 are readily incorporated into PDF files. In the case of HTML, images are typically incorporated as a separate file connected with the main HTML file by a hyperlink. The radiological image 54 and associated annotations 56 may be accessible through a general bookmark such as the “Discharge Summaries” bookmark 58 of the PDF bookmarks 40, or may be indexed under a designated bookmark such as a “Radiological images” bookmark (not included in FIG. 5).

With returning reference to FIG. 5, the bookmarked or otherwise indexed information can also optionally include a bookmark 59 (entitled “Learning Needs” in the example PDF bookmarks 40 of FIG. 5) to the IEP file 15. The bookmarked or otherwise indexed information can also optionally include one or more legal documents including a signature of the associated person authorizing selected actions in delivering emergency aid to the associated person. For example, the example PDF bookmarks 40 include links to: a consent to treat authorization; a Health Insurance Portability and Accountability Act (HIPAA) information release authorization; and a living will. Other legal documents that may be included include a durable power of attorney authorizing another to make medical decisions for the associated person in the event the associated person is unconscious or otherwise unable to communicate.

With reference to FIG. 9, a selected portion of an example living will 60 is shown, which is accessible via the “Living Will” bookmark 62 of the PDF bookmarks 40 shown in FIG. 5. The living will includes a digital image of a signature 66 of the associated person and a digital image of a witness' signature 68. In addition to or instead of witnessing, the legal document can be notarized. Moreover, it is contemplated that some of the stored legal documents may be neither witnessed nor notarized. Instead of the illustrated digital images of handwritten signatures 66, 68, it is also contemplated to employ digital signatures or “e-signatures” to validate legal documents contained in the current medical profile data file 14.

In the illustrated embodiments, the contents of the current medical profile data file 14 are displayed on a display of the computer 12. In some embodiments, it is also contemplated to employ audio dictation output. For example, Adobe PDF Reader version 6 includes audio dictation capability. In such embodiments, selected contents of the current medical profile data file 14 are suitably “read aloud” by the computer 12, thus freeing emergency medical personnel to tend to the emergency of the associated person while listening to the computer 12 dictate the selected contents of the current medical profile data file 14.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

The appended claims follow:

1. A medical information device comprising:
a portable non-volatile digital memory device adapted for detachable connection with a computer; and
at least one current medical profile data file stored unencrypted and without password protection on the portable non-volatile digital memory device, the at least one current medical profile data file containing information relevant to delivering emergency aid to an associated person in the event of a medical emergency.

2. The medical information device as set forth in claim 1, further comprising:
visual indicia coupled with the portable non-volatile digital memory device alerting emergency personnel that the portable non-volatile digital memory device stores information relevant to delivering emergency aid to the associated person.

3. The medical information device as set forth in claim 1, wherein the portable non-volatile digital memory device includes a Universal Serial Bus (USB) interface for detachably connecting with the computer.

4. The medical information device as set forth in claim 1, wherein the at least one current medical profile data file consists of only a single current medical profile data file stored unencrypted and without password protection on the portable non-volatile digital memory device.

5. The medical information device as set forth in claim 1, wherein the at least one current medical profile data file is stored in a non-proprietary data format.

6. The medical information device as set forth in claim 1, wherein the at least one current medical profile data file is a Portable Document Format (PDF) file.

7. The medical information device as set forth in claim 1, wherein the information relevant to delivering emergency aid to the associated person contained in the at least one current medical profile data file comprises at least an identification image of the associated person, emergency contact information, primary physician identification, a list of medications prescribed to the associated person, a list of allergies of the associated person, and information on medical insurance carried by the associated person.

8. The medical information device as set forth in claim 1, wherein the information relevant to delivering emergency aid to the associated person contained in the at least one current medical profile data file comprises at least primary physician identification and an emergency first aid protocol specifically tailored to the associated person.

9. The medical information device as set forth in claim 1, wherein the information relevant to delivering emergency aid to the associated person contained in the at least one current medical profile data file comprises one or more legal documents including a signature of the associated person authorizing selected actions in delivering emergency aid to the associated person.

10. The medical information device as set forth in claim 9, wherein the signature of the associated person is one of (i) an image of a handwritten signature, and (ii) a digital signature.

11. The medical information device as set forth in claim 9, wherein the one or more legal documents comprise at least one of a living will and a durable power of attorney signed by the associated person.

12. The medical information device as set forth in claim 1, wherein:
the at least one current medical profile data file is stored in a non-proprietary data format, and
the portable non-volatile digital memory device does not store computer executable instructions for accessing the at least one unencrypted medical data file.

13. A medical information device comprising:
a portable USB memory drive adapted for detachable connection with a USB port of a computer;
a current medical profile Portable Document Format (PDF) file stored on the portable USB memory drive and containing information relevant to delivering emergency aid to an associated person in the event of a medical emergency; and
visual indicia coupled with the portable USB memory drive alerting emergency personnel that the portable USB memory drive contains information relevant to delivering emergency aid to the associated person.

14. The medical information device as set forth in claim 13, wherein the portable USB memory drive is a USB FLASH memory drive.

15. The medical information device as set forth in claim 13, wherein the portable USB memory drive does not store any files containing computer executable instructions.

16. The medical information device as set forth in claim 13, wherein the portable USB memory drive stores only the current medical profile PDF file and does not store any other files.

17. The medical information device set forth in claim 13, wherein the associated person is a handicapped child, the medical information device further comprising:
an IEP file stored on the portable USB memory drive and containing an independent educational program (IEP) tailored to the handicapped child.

18. The medical information device set forth in claim 17, wherein the current medical profile PDF file includes a link to the IEP file.

19. The medical information device as set forth in claim 13, wherein the current medical profile PDF file is stored on the portable USB memory drive unencrypted and without password protection.

20. The medical information device as set forth in claim 13, wherein the information relevant to delivering emergency aid contained in the current medical profile PDF file includes a radiological image of at least a portion of the associated person.

21. A medical information retrieval method comprising:
carrying a portable non-volatile digital memory device adapted for detachable connection with a computer, the portable non-volatile digital memory device storing a current medical profile data file unencrypted and without password protection, the current medical profile data file containing information relevant to delivering emergency aid to an associated person carrying the portable non-volatile digital memory device in the event of a medical emergency; and
responsive to a medical emergency, connecting the portable non-volatile digital memory device with a computer; and
after the connecting, opening the stored current medical profile data file using a general-application software program not residing on the portable non-volatile digital memory device.

22. The medical information retrieval method as set forth in claim 21, wherein the portable non-volatile digital memory device is a USB memory drive, and the connecting causes the USB memory drive to appear as a removable drive on the computer.

23. The medical information retrieval method as set forth in claim 21, wherein the current medical profile data file is a PDF file, and the opening comprises opening said PDF file using a copy of Adobe PDF reader software stored on a non-volatile memory device other than the portable non-volatile digital memory device.

24. The medical information retrieval method as set forth in claim 21, further comprising:
providing visual indicia coupled with the portable non-volatile digital memory device alerting emergency personnel that the portable non-volatile digital memory device contains information relevant to delivering emergency aid to the associated person.
